(19) United States
(12) Patent Application Publication
(10) Pub. No.: US 2008/0255908 A1
(43) Pub. Date: Oct. 16, 2008

(54) GENERIC FRAMEWORK FOR RESOURCE MODELING

(76) Inventors: Gary S. Smith, Castle Rock, CO (US); Aaron P. Swanson, Morrison, CO (US)

Correspondence Address: KUTAK ROCK, LLP, 1801 CALIFORNIA STREET, SUITE 3100, DENVER, CO, 80202-2626, US

(21) Appl. No.: 11/735,364

(22) Filed: Apr. 13, 2007

(51) Int. Cl. G06Q 10/00

(52) U.S. Cl. 705/8

(57) ABSTRACT

Provided is a generic framework for resource modeling to assist in scheduling tasks. More specifically the model provides a structure and method for receiving a task having at least one resource requirement. Upon receipt of such a task, a set of compliant resources are retrieved. A graph is generated to indicate one or more resource paths, each path running through a subset of the compliant resources. Each resource is represented as a node on the graph, and each resource has at least one characteristic. A characteristic common to all nodes on each path is then selected and plotted upon a continuum. Each path is then evaluated to determine path viability. Path viability is indicated by a common intersection upon the continuum of the selected characteristic for all nodes along the path.

### FIELD

This invention relates generally to the scheduling of new activities in a schedule, and, in particular, to a system which permits insertion, deletion, and modification of activities rated by priority without removing higher priority activities, wherein the collection of items to schedule is decomposed into subsets of items based on some criteria.

### BACKGROUND

Simply stated, a schedule informs a party of what activity/activities are to take place, when the activity/activities will take place, and who will perform the activity/activities. A schedule may run for an hour, day, week, month, or other interval of time. Generally, the “when” quality is a specific reference to start an activity at a specific time and/or end that activity at a later specific time.

With respect to the “what” quality, a schedule may provide very generic activity information such as sleeping, eating, building, or some other activity. The “what” quality may also provide resource information—sleeping in bed 2, eating at table 5, or building at station 4.

With respect to the “who” quality—a schedule may provide information to observers of an activity regarding who is performing the activity, or the schedule may provide direction to a party to commence with or finish an activity. Typically, a schedule will also indicate free time, as in unscheduled time, as well as the busy time, as in time currently scheduled for activities.

More often then not, an activity that is to be scheduled involves one or more resources. For any given resources (such as an aircraft, a satellite or a computer) there may be a finite availability both in terms of how long something may occur and how much may occur. Computer speeds are continuing to increase, but for each second of time a computer (CPU) has a finite number of operations to perform. A more powerful CPU resource may indeed execute more operations than a less powerful CPU resource, and such an option may or may not be taken into account when forming a schedule. In another example, an aircraft or satellite may not be over a particular spot on the earth at all times, and even when over a target area, may only be able to observe, deploy, gather, or perform a finite number of activities before returning to base or passing out of range.

In the effort to schedule multiple activities, often times a sub issue arises with respect to the scheduling of resources that are needed for the performance of the desired tasks. For example consider two different tasks to gather reconnaissance information from different geographic areas. If these two tasks are to be accomplished contemporaneously then different resources must be allocated to each, and of course each of those resources must be available.

Indeed, in the scheduling of multiple tasks often times there are overlaps with respect to the resources in use, and/or even which of a plurality of different resources can be used. One task might requite a resource that can be supplied by a number of different options, however Resource Option A might preclude one or more subsequent tasks from being performed, while Resource Option B would allow all subsequent tasks to be performed. It therefore often becomes necessary to evaluate and compare the resource options in the process of developing a viable schedule.

To fill a schedule with activities competing for time slots and resources, or to enter new activities into an existing schedule where the new activities compete with existing scheduled activities is far from easy. Many problems, and the algorithms that may be applied to them, are linear—double or triple the input and they will take twice or three times as long to complete. Others may be quadratic, cubic or another polynomial. When a class of problems is encountered where the solution is not polynomial, it may well be a nondeterministic polynomial—more commonly referred to as “NP-hard”.

Determining a schedule of resource availability for tasks to be scheduled is an activity that qualifies as NP-hard. NP-hard problems are well known and frequently encountered, yet no algorithm to solve them to optimality in polynomial time is known. A fast algorithm is one that will return the best solution quickly enough for the solution to actually be useful. If the solution takes years to compute, it is quite likely that the term of usefulness will have long expired.

A famous example of such an NP-hard problem is the Traveling Salesman. A salesman desires to visit each state capital and wants to minimize his or her driving time. Within the 50 states there are 49! possible choices—and no algorithm is known to exist that will solve this problem in a reasonable amount of time.

When determining resource allocation for a number of tasks to schedule, it may be that, given an infinite amount of time, a best solution may be found. However, during the instantiation of a schedule, and the subsequent modification of a schedule, real time continues to progress. As a result, by the time a best solution has been found, it is entirely possible that too much time will have passed and the issue will be moot.

In many instances, scheduling algorithms applicable to tasks, of resources to support those tasks, are designed on a case by case basis to address what is perceived as a specific scheduling need. Although effective, this can lead to significant inefficiency as many scheduling systems may utilize similar if not identical operations. In addition, if an issue of priority affecting one or more tasks changes suddenly due to a real world crisis, a customized algorithm may be unable to favorably adapt.

Indeed there are many different types of scheduling methodologies, and even for the same type of event scheduling, different methodologies may be more of less favored at different times.

Where the desire is to schedule the maximum number of activities, regardless of priority, an English Auction may be quite effective. However, if there is a premium placed on the scheduling of higher priority activities, then an English Auction may not offer the best solution. Indeed, if the mandate is to schedule as many events as possible, but no higher priority activity may ever be usurped by one or more lower priorities, then the English Auction approach will not be acceptable. And again, though an English Auction method may be appropriate for some tasks in a scheduling problem it may not be the most desirable method for all tasks in the scheduling problem.

Mixed Integer methods have also been proposed to provide schedule modification. In a Mixed Integer method, however, each and every allowable possible permutation of activities is considered and evaluated. Even with the speed of modern computers, the focus upon trying all permutations for comparison makes Mixed Integer methods vastly impractical for large scale scheduling problems, but may be ideal for small, time insensitive problems.

Further a system designed to effectively process on-demand tasking may not be ideal for scheduling and rescheduling a list of standing or repeated tasks known to occur at some point beyond the immediate here and now.

Hence, there is a need for a resource modeling method to assist with the scheduling of tasks that overcomes one or, more of the technical problems found in existing scheduling systems.

### SUMMARY

This invention provides a generic framework for resource modeling.

In particular, and by way of example only, according to one embodiment of the present invention, a method is provided for a generic framework of determining a resource model path including: receiving a task having at least one resource requirement; retrieving a set of compliant resources; graphing at least one path through a subset of the compliant resources, each resource represented as a node on the graph, each resource having at least one characteristic, plotting a selected characteristic common among the subset of resources upon a continuum; and evaluating each path to determine path viability, path viability indicated by a common intersection upon the continuum of all characteristics for the nodes along the path.

In yet another embodiment, provided is a generic framework method of determining a generic resource model path including: providing an acyclic resource graph, the resource graph representing at least one operation path, each path including resource nodes, each node indicating at least one characteristic; accepting at least one operation objective; plotting upon a continuum a selected characteristic common among the resource nodes; and evaluating each path to determine path viability with respect to the objective, path viability indicated by a common intersection upon the continuum of all characteristics for the nodes along the path.

Further, in another embodiment, provided is a resource modeling generic framework including: a receiver operable to receive a task and identify at least one resource associated with the task, the receiver further operable to receive a set of compliant resources; a node templator operable to establish a template node representative of the compliant resources; a grapher operable to graph at least one path through a subset of the compliant recourses, each resource represented as a node on the graph, each resource having at least one characteristic; a plotter operable to plot a selected characteristic common among the subset of resources upon a continuum; and an evaluator operable to evaluate each path to determine path viability, path viability indicated by a common intersection upon the continuum of all characteristics for the nodes along the path.

In yet still another embodiment, provided is a computer-leadable medium on which is stored a computer program for modeling resource use, the computer program including instructions which, when executed by a computer, perform the steps of receiving a task having at least one resource requirement; retrieving a set of compliant resources; graphing at least one path through a subset of the compliant resources, each resource represented as a node on the graph, each resource having at least one characteristic, plotting a selected characteristic common among the subset of resources upon a continuum; and evaluating each path to determine path viability, path viability indicated by a common intersection upon the continuum of all characteristics for the nodes along the path.

### BRIEF DESCRIPTION OF THE DRAWINGS

FIG. 1 illustrates a high level block diagram of a generic framework for resource modeling in accordance with an embodiment;

FIG. 2 is a graph of resource path options for an exemplary task and a plot of the common intersections of at least one characteristic for, each resources along each path, in accordance with at least one embodiment;

FIG. 3 is a flow diagram of the generic resource framework modeling method in accordance with an embodiment; and

FIG. 4 is a block diagram of a computer system in accordance with one or more embodiments.

### DETAILED DESCRIPTION

Before proceeding with the detailed description, it is to be appreciated that the present teaching is by way of example only, not by limitation. The concepts herein are not limited to use or application with a specific type of scheduler or resource modeling framework. Thus, although the instrumentalities described herein are for the convenience of explanation, shown and described with respect to exemplary embodiments, it will be appreciated that the principles herein may be applied equally in other types of scheduling systems.

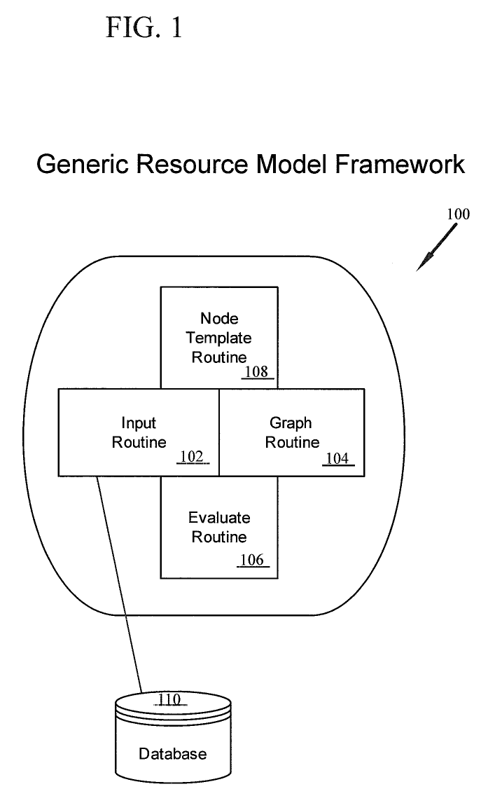

FIG. 1 is a high level block diagram of the computer program architecture for a generic resource modeling framework “GRMF” 100 in accordance with at least one embodiment. GRMF 100 may be implemented on a computer having typical components such as a processor, memory, storage devices, and input and output devices. During operation, the GRMF 100 may be maintained in active memory for enhanced speed and efficiency. In addition, it may also be operated within a computer network and may utilize distributed resources. Further, GRMF 100 is in at least one embodiment an application that is operable as a part of a larger scheduling system.

When scheduling a task that utilizes resources, GRMF 100 is used to evaluate different resource paths with respect to at least one objective. More specifically, GRMF 100 is operable to compare and evaluate different resource path options in an automated fashion so as to deliver the best resource path option for a given task. As is further explained below, GRMF 100 is utilized in real time to determine a potential resource path for at least one user provided objective.

It is understood and appreciated that as used herein, a user is typically a human user. However as GRMF 100 may be invoked as a sub-application to a scheduling system, the schedule system may assume the roll of the actual end user in supplying GRMF 100 with the necessary task data and one or more objectives.

As shown in FIG. 1, GRMF 100 includes an input routine 102, a graphing routine 104, and an evaluation routine 106. As the GRMF 100 is by nature intended to be flexible and reusable, it also includes a define template node routine 108.

The input routine 102 is set to receive information, such as a task or information defining a template node for resource path graphing. The input routine 102 may receive this information directly from a user through an associated input device, or, directly from an instantiating application. The resources that might be associated with a task can also be provided by a user, and/or a resource database 110. Indeed, if not otherwise specified by the user directly, it is understood and appreciated that there is a related index and/or database 110 that identifies the resources related to the task. For example, a user may provide input indicating that the task is a recon operation for a remote area of geography that must be performed in the next hour and that such reconnaissance is to be performed by satellite. From the resource database 110, GRMF 100 will select satellites available in that general area. Each of the resources provided by the satellite, such as cameras, radar, sensors, or other devices are of course associated with the record for the satellite resource and need not be specifically specified by the user.

The graphing routine 104 is operable to graph resource options for a given task, (such as for example a spacecraft, sensors, batteries, optical camera) so as to present a one or more path options in a directed acyclic graph. More specifically, a path is a resource path, and is a valid combination of resources from the top level resource (a node with no edges entering to it), to a terminal resource (a node with no edges exiting from it).

The evaluation routine 106 is operable to evaluate each resource path for viability. As is further discussed below, in at least one embodiment the evaluation of resource path viability is indicated by a common intersection upon a continuum of a selected characteristic common to all resources along the path. Indeed, in at least one embodiment, the evaluation routine 106 formalizes the graph as a multidimensional optimization problem. More specifically, in at least one embodiment a multidimensional graph (the number of dimensions based on the number of attributes in each node), is generated and processed as a multidimensional optimization problem to find a common intersection path.

With respect to the GRMF 100 as shown in FIG. 1, in at least one embodiment the routines may be described as objects. For example, the input routine 102 is formally described as a receiver element. The receiver is operable to receive the task and receive a set of compliant resources for the task. The node template routine 108 is formally described as a node templator, operable to establish a template node representative of the compliant resources. More specifically, the node templator insures harmony among the variety of different resources that may be at issue, such harmony permitting the evaluation and determination of resource path viability as further described below.

The graph routine 104 is formally described as a grapher. The grapher is operable to graph at least one path through a subset of compliant resources. Each resource is represented as a node and precedence between the resources is indicated by the order along the path. As an integrated element of the grapher, or in certain embodiments a separate element, GRMF 100 also includes a plotter, which is operable to plot a selected characteristic common among the subset of resources upon a continuum.

The evaluation routine 106 is formalized as an evaluator. The evaluator is operable to evaluate each path to determine path viability. As is further discussed below, path viability is indicated by a common intersection upon the continuum of all characteristics for the nodes along the path.

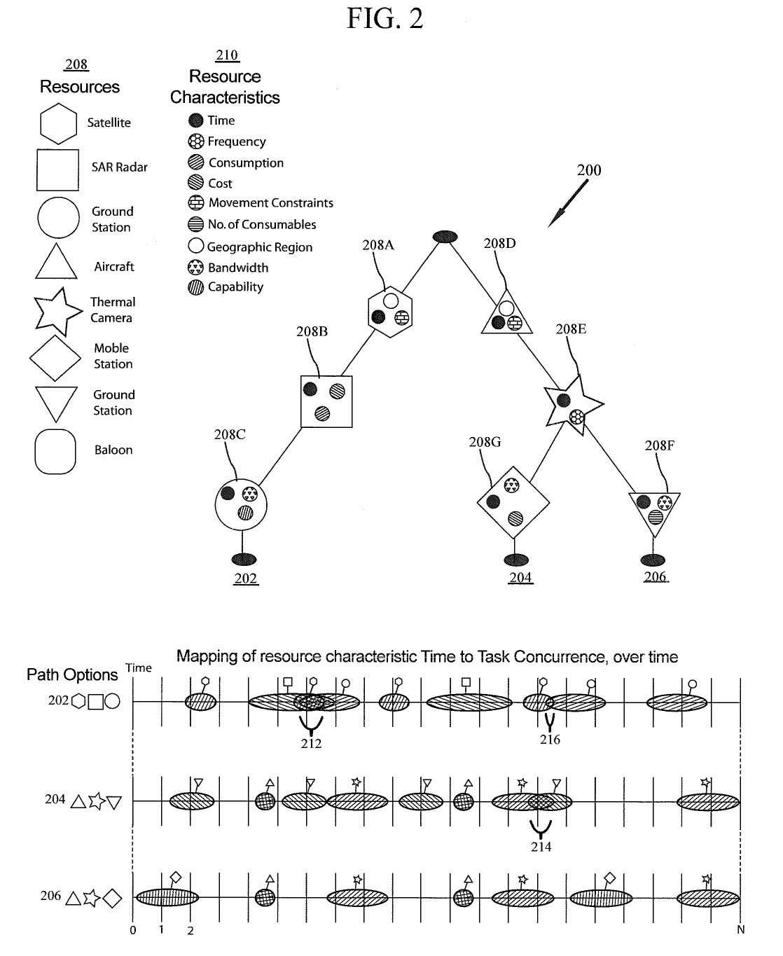

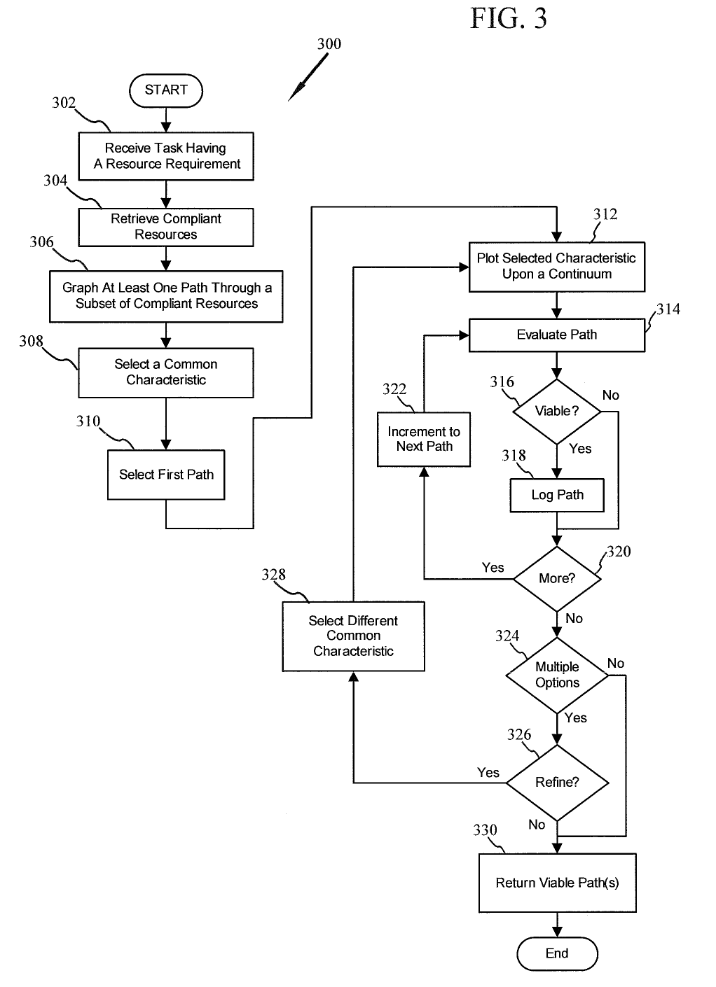

FIG. 2 illustrates a graph 200 depicting three resource paths, 202, 204 and 206, respectively. For the sake of example, a hypothetical scheduling problem involves a task to recon an area of remote geography. FIG. 3 provides a high level flow diagram that depicts the method 300 of determining a resource model path in accordance with at least one embodiment. It is also understood and appreciated that the disclosed method need not be performed in the order herein described, but that this order of description is exemplary of at least one embodiment and has been selected for ease of discussion and illustration.

For the accomplishment of the task, it is not uncommon for a variety of different resource options to present themselves. With respect to FIG. 2, each resource 208 is indicated by a different geometric shape. The use of different shapes is adopted in at least one embodiment to visually help identify the resources involved along the path, however in alternative embodiments it is acceptable for all resources to be indicated by the same geometric shape. It is also not uncommon for each resource 208 to have one or more resource characteristics 210, such as but not limited to time, frequency, cost consumption, movement constraints, number of consumables, geographic region, bandwidth, capability, or other factors.

As indicated by block 302, in at least one embodiment, the method 300 commences with the receipt of a task having at least one resource requirement. As stated, for the purposes of discussion an example task of recon upon a geographic area is the desired task. The resource requirements are simplified for purposes of discussion, but including such elements as time for performance, type of task (optical imaging, thermal imaging, acoustic imaging, SAR imaging, etc . . . ), consumables (remaining fuel, etc . . . ), resolution, and or time. Other resource requirements may be specified as well, and may be changed from one instance of GFRM 100 to another.

It is not uncommon for a variety of different resource options to possibly present themselves for the accomplishment of the task. As such, as indicated by block 304, a set of compliant resources are retrieved. With respect to the present example, one initial resource is a plane and a second initial resource is a satellite.

From the collected set of compliant resources, at least one path through a subset of compliant resources is graphed, block 306. It is also understood and appreciated, that in at least one embodiment, the user of GRMF 100 may have a resource path graph, such as from a previous task scheduling operation. The user may supply the graph to GRMF 100 and in so doing omit the need for GRMF 100 to graph the resource path options. It is of course understood and appreciated that when and where GRMF 100 receives a provided acyclic resource graph, such as graph 200, it is provided in a form that is compliant to GRMF 100.

With respect to FIG. 2, it is noted that as mentioned above, the precedence order of the resources is also indicated, i.e., it is necessary to first retrieve the plane resource before retrieving the camera resource and ground station resource. It is again noted that each resource path is acyclic.

In rendering the resource path graphs, there are several issues to be noted. The first is that the paths are representative of options that might satisfy a particular combination of resource requests to support a task. True viability of a path can be dependent upon a number of factors, and can change as the factors change. It has therefore been determined to be highly advantageous to render path options first so as to define the universe of options and then turn to the question of viability.

In addition, the operation of rendering paths before turning to the question of viability also permits the identification of path options that would be valid, but for some other tasks and resource allocation. This is highly advantageous. If the question asked is only “what is available” and not “what could work” important opportunities for improvement might be missed. This can be easily appreciated with respect to an example for a real time need for thermal imaging of a tsunami ravaged area to identify survivors. Determining a resource path conflict with a satellite based thermal imaging camera presently assigned to monitoring ocean upwelling currents may well permit faster re-tasking of the satellite resource and life saving opportunities that could otherwise be lost if only available resources were considered.

It is also understood and appreciated that the order of the nodes upon the path indicates in at least one embodiment the hierarchy of the nodes. In other words, first the vehicle is selected (e.g., a satellite or plane), and then the sensors that are available on that vehicle. Moreover, it is not possible to select a node representing a sensor on a vehicle without also selecting the node representing the vehicle upon which that sensor is attached, in other words, nodal relationships. In at least one embodiment, the node template routine 108 shown in FIG. 1 permits the definition of nodes that specify relationships.

To determine viability of a path or paths, at least one common characteristic is selected, block 308. For the purposes of the example in FIG. 2, this common characteristic is time. The selected common characteristic is then plotted upon a continuum. In at least one embodiment, the continuum is related to the selected characteristic. With respect to the common characteristic of time, in at least one embodiment the continuum is a time line of resource availability. Moreover, the paths 202, 204, 206 represents a combination of resources that would suffice to provided what the task requires, the graphing upon the continuum then demonstrates from the collection of path options that “might” work, what can work.

Moreover, as indicated in block 310, a first path is selected from the group of potential paths, 202, 204, 206. For example this is path 202. The selected characteristic is then plotted upon the continuum, block 312. In at least one embodiment, the continuum plot is a sub-element of the graph. In certain embodiment, the continuum and graph elements may be superimposed or otherwise closely related, however with respect to FIG. 2, the two elements have been shown separately to facilitate ease of illustration and discussion.

The plotted path is then evaluated to determine path viability, block 314. In at least one embodiment, path viability is indicated by a common intersection upon the continuum of all characteristics for the nodes along the path. With respect to the plotting upon the time continuum, it can be seen that for resource path 202, there is an instance of common intersection 212, for all three path resources 208A, 208B and 208C. As such, viability of resource path 202 is evaluated as yes, decision 316, and path 202 is logged as a viable option, block 318.

The process then continues for other remaining resource path options, decision 320, which in this case include resource paths 204 and 206. The method increments to the next path, such as for example resource path 204, which is plotted upon the continuum as was done for resource path 202. With respect to resource path 204, the evaluation of viability, decision 316, fails. More specifically, there is not an instance of common intersection for all path resources, 208D, 208E and 208F. There is an instance 214 where two resources ate available and overlap, e.g., 208E and 208F, but resource 208D is absent. An instance 216 of two intersecting resources 208A and 208C is also present for resource path 202, however that intersection is superseded by the complete intersection 212.

Identification of a partial intersection such as 214 and 216 may be useful in re-evaluating possible re-tasking of resources, and therefore in at least one embodiment, these partial intersections may be logged as well.

As the method continues and increments to the remaining resource path 206, block 322, the final resource path 206 is again plotted upon a continuum and evaluated for instances of common intersection. With respect to resource path 206 there are no points of intersection between the resource at all, and as such, resource path 206 is evaluated as non-viable, decision 316.

When each possible resource path has been evaluated, in at least one embodiment where there are multiple viable options, decision 324, the method proceeds to address the question of whether further refinement of the resource path options is desired, decision 326. In at least one embodiment, refinement is a user specified option. In at least one alternative embodiment, refinement is triggered by the number of viable paths being over a threshold, this threshold being user definable from a default initial value.

In response to a positive decision to refine, decision 326, a different common characteristic is selected, block 328. The continuum is also re-selected and the plotting and evaluation re-performed for the new selected common characteristic, blocks/decisions 312, 314, 316, 318, 320, and 322. By such operation the field of viable resource paths is narrowed.

Should the decision to refine not be selected, decision 326, the method continues to return the viable path or paths, block 330. In the event that no paths are evaluated as viable, in at least one embodiment the method 300 will return a no viable option found message to the user.

Representation of the resource path options, e.g., 202, 204 and 206 as an acyclic path advantageously permits enhanced comparison and perception of the various resource path options. Formalizing the resource path options for interpretation by a computer for automated processing may be accomplished in several ways. For example, in at least one embodiment, the graph is established as a table, such as an adjacency matrix. For each characteristic of a resource within a path, the plotting of the characteristics upon a continuum again is highly advantageous to permit enhanced comparison and perception of how the characteristics may interrelate. With respect to interpreting the continuum plotting, in at least one embodiment, this may be expressed as analyzing and determining unions of sets.

As at least one embodiment of the GRMF 100 utilizes a database, i.e., database 110 in FIG. 1, to retrieve resources 202, depending on system configuration, database 110 may in some embodiments include information as to what task is currently using a resource. For such configurations, method 300 can be directed to return viable paths when and where a common intersection would occur, if not for another scheduled task utilizing the resource. In addition, as GRMF 100 pulls resources from the database 110, the database 110 may set a flag so as to indicate that the resource may be in use. If a path is evaluated to be viable, in at least one embodiment, GRMF 100 will return an indication of successful use for the resource to the database 110 such that the flag may be maintained, set whereas other unsuccessful resources flags are released.

It should also be understood that many operations within the method 300, such as for example the plotting upon the continuum, may be performed in parallel. Indeed, multiple instantiations of GRMF 100 may be run concurrently.

As noted above, GRMF 100 is by definition intended to be a generic framework model that is adaptable from one task planning session to another. Such adaptability and generic framing is achieved in at least one embodiment through the use of the Extensible Markup Language, otherwise known as XML. XML provides a text-based means to describe and apply a three-based structure to information, XML code is understood and appreciated to consist of elements and attributes, and of course nested elements. Through the structured format, XML permits GRMF 100 to define a template resource for each task model.

More specifically, the input routine 102 receives from the user XML code that defines such elements as for example, the database location of data source containing resource information, the structure of the resource nodes and the number of characteristics each should be associated with, the common characteristics and their order of preference for selecting continuums and validating resource path options, etc . . . Indeed, by standardizing the input through XML, GRMF 100 is free to operate without additional overhead complexity. So long as XML translation is performed before engaging GRMF 100, or in real time with the engaging of GRMF 100, translation within GRMF 100 is advantageously moot. As a result GRMF 100 is advantageously operable to assist a scheduling system, but is scheduler independent. This advantageous autonomy of GRMF 100 advantageously simplifies the design and maintenance of the scheduler system(s) as well.

It is understood and appreciated that XML code may be used to establish a variety of template resource nodes, and to indicate a variety of different associations between resources and characteristics. Indeed, the flexibility of XML permits users of the GRMF 100 to revise and modify the template used to establish resource nodes when and as they choose without requiring a full redevelopment of the entire resource modeling framework.

In addition, in at least one embodiment, GRMF 100 also includes a binder. With respect to the elements of GRMF 100 as shown in FIG. 1, the binder in one embodiment is an element included in the Node Template Routine 108. The binder is operable to bind a run-time dynamic function or algorithm to a node. For example, if a node happens to be a significant consumer of power, as say a sensor system, then bound to the static node is a dynamic algorithm that computes the power consumption based on the needed operating mode of the sensor. Likewise, if the node is a vehicle object, such as a satellite, a thermal exposure algorithm may be bound to that node so as to compute how much time one side of the satellite is exposed to the sun, a condition that can cause undesirable thermal stress and/or overheating of internal components. Moreover it is understood and appreciated that the use of a binder in certain embodiments is an advantageous option that is easily accommodated by the adaptability of the node template route 108, and more generally the generic configurability of GRMF 100.

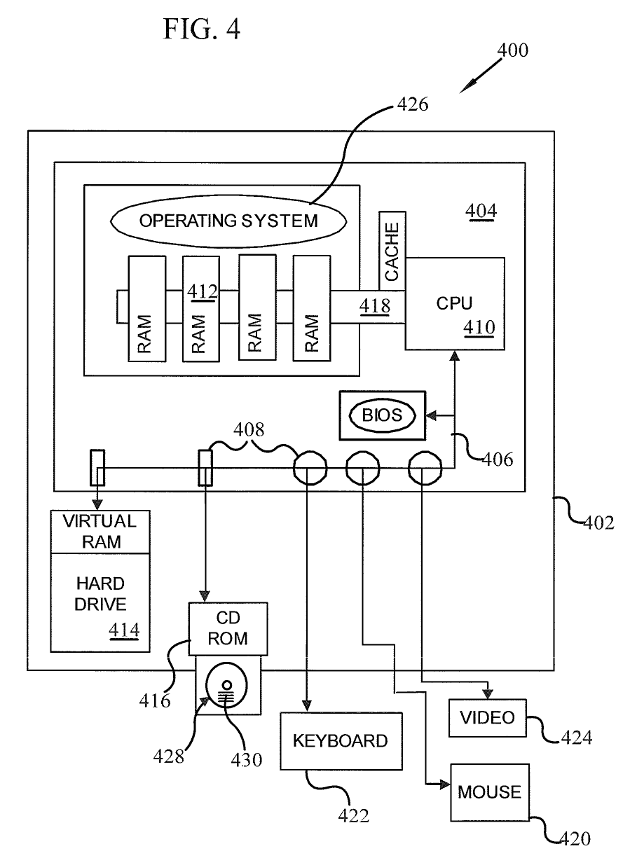

In at least one embodiment, the GRMF 100 is implemented as a computer system for scheduling activities. FIG. 4 is a high level block diagram of an exemplary computer system 400. Computer system 400 has a case 402, enclosing a main board 404. The main board has a system bus 406, connection ports 408, a processing unit, such as Central Processing Unit (CPU) 410, and a memory storage device, such as main memory 412, hard drive 414, and CD/DVD Rom drive 416.

Memory bus 418 couples main memory 412 to CPU 410. A system bus 406 couples hard drive 414, CD/DVD Rom drive 416, and connection ports 408 to CPU 410. Multiple input devices may be provided, such as for example a mouse 420 and keyboard 422. Multiple output devices may also be provided, such as for example a video monitor 424 and a printer (not shown).

Computer system 400 may be a commercially available system, such as a desktop workstation unit provided by IBM, Dell Computers, Gateway, Apple, Sun Micro Systems, or other computer system provided. Computer system 400 may also be a networked computer system, wherein memory storage components such as hard drive 414, additional CPUs 410 and output devices such as printers are provided by physically separate computer systems commonly tied together in the network. Those skilled in the art will understand and appreciate that physical composition of components and component interconnections comprising computer system 400, and select a computer system 400 suitable for the schedules to be established and maintained.

When computer system 400 is activated, preferably an operating system 426 will load into main memory 412 as part of the boot strap startup sequence and ready the computer system 400 for operation. At the simplest level, and in the most general sense, the tasks of an operating system fall into specific categories—process management, device management (including application and user interface management) and memory management.

In such a computer system 400, the CPU 410 is operable to perform one or more of the scheduling embodiments described above. Those skilled in the art will understand that a computer-unreadable medium 428 on which is a computer program 430 for adding activities to a schedule may be provided to the computer system 400. The form of the medium 428 and language of the program 430 are understood to be appropriate for computer system 400. Utilizing the memory stores, such as for example one or more hard drives 414 and main system memory 412, the operable CPU 402 will read the instructions provided by the computer program 430 and operate to perform the scheduling system 100 as described above.

Changes may be made in the above methods, systems and structures without departing from the scope hereof. It should thus be noted that the matter contained in the above description and/or shown in the accompanying drawings should be interpreted as illustrative and not in a limiting sense. The following claims are intended to cover all generic and specific features described herein, as well as all statements of the scope of the present method, system and structure, which, as a matter of language, might be said to fall therebetween.

What is claimed is:

1. A generic framework method of determining a resource model path comprising:
receiving a task having at least one resource requirement;
retrieving a set of compliant resources;
graphing at least one path through a subset of the compliant resources, each resource represented as a node on the graph, each resource having at least one characteristic;
plotting a selected characteristic common among the subset of resources upon a continuum; and
evaluating each path to determine path viability, path viability indicated by a common intersection upon the continuum of the selected characteristic for the all nodes along the path.

2. The method of claim 1, wherein the paths are acyclic.

3. The method of claim 1, wherein precedence is indicated by the order of the nodes along a given path.

4. The method of claim 1, wherein upon the determination of multiple viable paths, the method repeated for a different characteristic.

5. The method of claim 1, wherein the plot is a sub-element of the graph.

6. The method of claim 1, wherein the at least one characteristic is selected from the group consisting of: time, bandwidth, capability, frequency, consumption, movement constraints, number of consumables, capacity of consumables, geographic region, quality, duration, environmental restrictions, and combinations thereof.

7. The method of claim 1, wherein the continuum is related to the selected characteristic.

8. The method of claim 1, wherein each resource is established by an XML declaration and at least one XML nested element.

9. The method of claim 8, wherein multiple instantiations of the method may be performed concurrently, each utilizing resource elements defined by different XML declarations and nested elements.

10. A generic framework method for resource modeling comprising:
providing a resource template node, the resource template node further defined to have at least one specified characteristic;
generating a plurality of uniquely identifiable resources nodes from the template node, each having at least one characteristic;
receiving a task having at least one resource requirement;
retrieving a set of compliant resources nodes from the generated plurality of uniquely identifiable resources nodes;
graphing at least one path through a subset of the compliant resources nodes, the graph further including a plot upon a continuum of a selected characteristic common among the subset of resource nodes; and
evaluating each path to determine path viability with respect to at least one objective, path viability indicated by a common intersection upon the continuum of the selected characteristic for all the nodes along the path.

11. The method of claim 10, wherein the at least one characteristic is selected from the group consisting of: time, bandwidth, capability, frequency, consumption, movement constraints, number of consumables, capacity of consumables, geographic region, quality, duration, environmental restrictions, and combinations thereof.

12. The method of claim 10, wherein the continuum is related to the selected characteristic.

13. The method of claim 10, wherein upon the determination of multiple viable paths, the method repeated for a different characteristic.

14. The method of claim 10, wherein the template node is represented as a XML data structure, the uniquely identifiable resource nodes generated by supplying a delineated stream of XML data.

15. The method of claim 14, wherein each resource is established by an XML declaration and at least one XML nested element.

16. The method of claim 15, wherein multiple instantiations of the method may be performed concurrently, each utilizing resource elements defined by different XML declarations and nested elements.

17. A generic framework method of determining a generic resource model path comprising:
providing an acyclic resource graph, the resource graph representing at least one operation path, each path including resource nodes, each node indicating at least one characteristic;
accepting at least one operation objective;
plotting upon a continuum a selected characteristic common among the resource nodes; and
evaluating each path to determine path viability with respect to the objective, path viability indicated by a common intersection upon the continuum of the selected characteristics for all the nodes along the path.

18. The method of claim 17, wherein the at least one characteristic is selected from the group consisting of: time, bandwidth, capability, frequency, consumption, movement constraints, number of consumables, capacity of consumables, geographic region, quality, duration, environmental restrictions, and combinations thereof.

19. The method of claim 17, wherein the continuum is related to the selected characteristic.

20. A resource modeling generic framework comprising:
a receivers operable to receive a task and identify at least one resource associated with the task, the receiver further operable to receive a set of compliant resources;
a node templator operable to establish a template node representative of the compliant resources;
a grapher operable to graph at least one path through a subset of the compliant recourses, each resource represented as a node on the graph, each resource having at least one characteristic;
a plotter operable to plot a selected characteristic common among the subset of resources upon a continuum; and
an evaluator operable to evaluate each path to determine path viability, path viability indicated by a common intersection upon the continuum of the selected characteristics for all the nodes along the path.

21. The generic framework of claim 20, wherein precedence is indicated by the order of the nodes along a given path.

22. The generic framework of claim 20, wherein the plot generated by the plotter is a sub-element of the graph.

23. The generic framework of claim 20, wherein the at least one characteristic is selected from the group consisting of: time, bandwidth, capability, frequency, consumption, movement constraints, number of consumables, capacity of consumables, geographic region, quality, duration, environmental restrictions, and combinations thereof.

24. The generic framework of claim 20, wherein the continuum is related to the selected characteristic.

25. A computer-readable medium on which is stored a computer program for modeling resources, the computer program comprising instructions which, when executed by a computer, perform the steps of:
receiving a task having at least one resource requirement;
retrieving a set of compliant resources;
graphing at least one path through a subset of the compliant resources, each resource represented as a node on the graph, each resource having at least one characteristic,
plotting a selected characteristic common among the subset of resources upon a continuum; and
evaluating each path to determine path viability, path viability indicated by a common intersection upon the continuum of the selected characteristic for all the nodes along the path.

26. The computer-readable medium of claim 25, wherein multiple instantiations of the method may be performed concurrently, each utilizing resource elements defined by different XML declarations and nested elements.

27. The computer-readable medium of claim 25, wherein each resource is established by an XML declaration and at least one XML nested element.

28. A computer system for scheduling activities comprising:
a processing unit;
a memory storage device coupled to the processing unit;
an input device coupled to the processing unit; and
an output device coupled to the processing unit;
the processing unit being operative to:
receiving a task having at least one resource requirement;
retrieving a set of compliant resources;
graphing at least one path through a subset of the compliant resources, each resource represented as a node on the graph, each resource having at least one characteristic,
plotting a selected characteristic common among the subset of resources upon a continuum; and
evaluating each path to determine path viability, path viability indicated by a common intersection upon the continuum of the selected characteristic for all the nodes along the path.

29. The computer system of claim 28, wherein precedence is indicated by the order of the nodes

30. The computer system of claim 28, wherein the plot is a sub-element of the graph.

31. The computer system of claim 28, wherein the at least one characteristic is selected from the group consisting of: time, bandwidth, capability, frequency, consumption, movement constraints, number of consumables, capacity of consumables, geographic region, quality, duration, environmental restrictions, and combinations thereof.

32. The computer system of claim 28, wherein the continuum is related to the selected characteristic.

33. The computer system of claim 28, wherein each resource is established by an XML declaration and at least one XML nested element.
